(19) United States
(12) Patent Application Publication
(10) Pub. No.: US 2022/0325104 A1
(43) Pub. Date: Oct. 13, 2022

(54) Manufacturing Process for Components from Coffee Grounds and Their Use

(71) Applicant: ecobrain AG, Zug (CH)

(72) Inventor: Dunja VOOS, Solingen (DE)

(21) Appl. No.: 17/642,544

(22) PCT Filed: Jul. 2, 2020
(86) PCT No.: PCT/EP2020/068726

§ 371 Date: Mar. 11, 2022

(30) Foreign Application Priority Data
Sep. 3, 2019 (DE) 10 2019 213 975.2

(51) Int. Cl. C08L 99/00; A23F 5/06; A23F 5/08; C08J 3/00; C08J 3/20

(52) U.S. Cl. CPC C08L 99/00; A23F 5/06; A23F 5/08; C08J 3/005; C08J 3/20; C08J 2499/00

(57) ABSTRACT

Disclosed is a process for producing a thermoformable and/or embossable particle/polymer composite using a ground particulate biological substrate S of nutrient tissue and a polymer P, characterized in that
(i) the substrate S and the polymer P are homogeneously mixed, then
(ii) the substrate S/polymer P mixture is converted into a particle layer, and thereafter
(iii) the resulting particle layer is densified at a temperature higher than or equal to the glass transition temperature of the polymer P [Tg^{P}] to form a thermoformable and/or embossable particle/polymer composite,
   where
(a) the substrate S comprises extracted ground coffee beans; and
(b) the polymer P is thermoplastic and has a Tg^{P}≥20° C. measured according to DIN EN ISO 11357-2 (2013-09).

Furthermore, a process for the manufacturing of a particle/polymer molding, a particle/polymer molding and its use as an element in buildings or in furniture are disclosed.

The invention relates to a process for producing thermoformable and/or embossable particle/polymer composites and their use as components. In particular the particles comprise ground, roasted and extracted coffee beans (coffee grounds).

### BACKGROUND

One of the major challenges facing humanity in recent years is the reduction of CO₂ emissions in the earth's atmosphere. On the one hand, this is achieved by reducing the use of fossil fuels, but on the other hand, processes for storing CO₂ in the earth are also being investigated. In principle, a first step is the increased use of renewable raw materials in technical areas such as automotive, consumer goods etc., which temporarily store CO₂ at least for a few years and are neutral in the CO₂ balance in the short term during this phase of use.

These include, for example, biodegradable starch films or veneer woods which, modified accordingly, are used as paneling in car interiors.

It would be particularly desirable if not only newly produced materials could be used for such applications, but also raw materials that would otherwise be discarded as waste.

A raw material relevant to the invention is coffee grounds (CG). This is produced in large quantities worldwide (up to 4 million tons in Europe per year) and is usually either burned or added as soil fertilizer. In both cases, it is converted to CO₂ in the short term. A medium-term storage of CO₂ is not possible here.

More recent approaches attempt to use coffee grounds as a component of a composite raw material.

For example, document DE 10 2017 118881 A1 describes the use of coffee grounds in combination with olefins and/or other natural substances such as cellulose and starch. However, a maximum of up to 40% coffee grounds can be used in the described products to produce compoundable granulates. In addition, the injection molding process proposed here is relatively costly due to the required machines and injection molded parts.

Document CN102807760 describes a composite material with up to 70% coffee grounds. Other components are mainly polyethylene and polypropylene. Here too, the raw materials are mixed and granulated by extrusion and can then be processed by injection molding.

Document CN105542498 describes a similar composition, the silverskins of the coffee beans being used as the raw material.

In CN107141552, polyethylene and other additives are combined with coffee residues, but these account only for a ratio of 10-25%.

Patent applications CN108727700 and CN108841114 combine synthetic polymers with silverskins of coffee beans. Here, the silverskins are only considered as a small filler content (12-18% and 25-35% respectively).

Canadian patent application CA3028368A1 describes the manufacturing of a plastic from biomass, in this case the silverskin of the coffee bean.

US application 2014/0023788 describes the manufacturing of a synthetic stone using coffee grounds (preferably 25%), polymer resins and fillers.

GB 1 207 801 A discloses a process for the preparation of resin compositions wherein ground coffee bean wastes are used as filler and/or lubricant. The coffee bean wastes are previously de-oiled. In the examples, the resins are thermosetting (phenol-formaldehyde resin, especially Novolak); however, thermoplastic resins in a very general form are also mentioned in the introduction. The ground coffee is dried to less than 10% by weight water content before being mixed with the resin. The process of GB 1 207 801 A comprises the steps of drying to 7.5% by weight water content and de-oiling the coffee grounds to a residual oil content of 1% by weight by extraction with petroleum ether, grinding, sieving, mixing with phenol-formaldehyde resin and producing moldings in a usual manner.

US 2006/0194900 A1 discloses a process for obtaining a thermosetting polymer composition having coffee bean residues as primary constituent. The process comprises the steps of washing the coffee grounds, mixing with starch, melamine resin, talc, calcium carbonate and fibrous filler, preheating and heat curing, e.g. in a mold. The document relates exclusively to thermosetting plastics. The amount of ground coffee is varied to adjust the colour of the composite. Before processing, the ground coffee is dried to a water content of less than 15% by weight. Starch and other auxiliaries are added to the mixture as further components.

WO 2018/078391 A2 discloses a bio-composite material comprising protein-containing non-wood fibrous biomass and a cross-linking agent. The disclosed invention concerns in the 1^{st} aspect a type of plywood in which, among other things, coffee grounds (among other protein-containing fibrous biomass products) are pressed with resin. Resins based on formaldehyde are disclosed, as well as wood glue without formaldehyde. The resin is mixed with other fibers and coffee grounds, transferred to a mold and pressed to form a matrix. This is then hot pressed. The process according to this document comprises preparation of a mixture and extrusion to produce pellets suitable for injection or blow molding.

The object of the present invention is therefore to provide a process for producing a thermoformable and/or embossable particle/polymer composite and a particle/polymer molded part obtainable therefrom, which on the one hand has a high proportion of coffee grounds and, on the other hand, can be produced at low cost.

This object is achieved by the process according to claim 1.

The object of the present invention is therefore a process for manufacturing a thermoformable and/or embossable particle/polymer composite using a ground particulate biological substrate S of nutrient tissue and a polymer P, characterized in that
(i) the substrate S and the polymer P are homogeneously mixed, then
(ii) the substrate S/polymer P mixture is converted into a particle layer, and thereafter
(iii) the particle layer obtained is compacted at a temperature greater than or equal to the glass transition temperature of the polymer P [Tg^{P}] to form a thermoformable and/or embossable particle/polymer composite,
   where
(a) the substrate S comprises extracted ground coffee beans; and
(b) the polymer P is thermoplastic and has a Tg^{P}≥20° C. measured according to DIN EN ISO 11357-2 (2013-09).

Furthermore, the subject matter of the present invention are the particle/polymer composites themselves, which are obtainable according to the method according to the invention, as well as their use for the manufacturing of particle/polymer moldings, such as elements in buildings such as wall panels, room dividers, floors, tiles, counters and in furniture.

### DESCRIPTION OF THE FIGURES

FIGS. 1 to 3 show exemplary laminate structures for molded bodies according to the invention.

### DETAILED DESCRIPTION OF THE INVENTION

A characteristic feature of the process according to the invention is that a ground particulate biological substrate S of nutrient tissue is used to produce the particle/polymer composite. According to the invention, all particulate biological substrates can be used.

A particulate biological substrate should preferably be understood as particles obtained from coffee grounds.

Other suitable biological substrates from nutritive tissue are, for example, nutritive tissue such as barley or rye.

Nutritive tissue means plant tissue enriched with reserve substances for the nutrition of the seedling.

The particulate biological substrates S from tissue are preferably essentially roasted and ground and then extracted barley, rye and coffee beans.

The biological substrate S consists particularly preferably of nutrient tissue from roasted, ground and subsequently extracted coffee beans.

According to the invention, the biological substrate does not contain significant amounts of silverskin from coffee beans. Significant amounts are amounts of silverskins not completely removed from the coffee grounds or intentionally added. Production-related residues of silverskin, stems or leaves may be present in small amounts in the biological substrate S from nutritive tissue according to the invention.

The coffee bean is the seed of the coffee cherry, which is surrounded by the silverskin (a protective coating that adheres directly to the seed), the parchment skin, the pectin layer and the pulp and fruit skin. After removing the various layers, the coffee bean is dried, roasted and then ground.

For example, roasted ground extracted coffee beans are coffee grounds produced in the usual way when making coffee, e.g. in a filter coffee maker, fully automatic coffee maker, strainer coffee machine, French coffee maker, espresso pot, in standard coffee capsules or coffee pads or by hand filtering. The coffee powder is extracted within a short time, i.e. a few seconds to a few minutes, by hot water or steam (e.g. at 80 to 100° C.). Extraction can take place under normal pressure, but also under enhanced pressure, e.g. in strainer coffee machine at up to 12 bar.

Coffee grounds are also industrially produced in large quantities in manufacturing of instant coffee (soluble coffee).

According to the invention, all these types of coffee grounds can be used as biological substrate S from nutritive tissue.

The particle size of coffee powder is usually indicated as the degree of grinding in various stages (e.g. 1 to 6, or up to 10 or even 12 depending on the manufacturer) from “very fine” to “very coarse”. Coarsely ground coffee has a particle size of approx. 1 mm, and finely ground coffee approx. 0.3 mm.

The particle size of the coffee particles according to the invention can include all the usual grinding degrees even in industrial grinding and can be determined, for example, by standard sieve analysis.

According to the present invention, it is not required to further grind the extracted coffee grounds in order to obtain to a specific particle size or particle size distribution.

The coffee grounds are dried after extraction, under normal conditions or by conventional drying methods (e.g. rotary kiln dryer, convection dryer, fluidized bed dryer, microwave dryer), preferably to a residual moisture content of 15% by weight, preferably 10% by weight, even more preferably 5% by weight, before being used in the process according to the invention.

The coffee grounds can be used without de-oiling according to the invention. Surprisingly, it has been found by the inventors that even an aqueous binder dispersion can be used in the inventive process without previously de-oiling the coffee grounds, although it would have been expected that aqueous dispersions are not compatible with oily substances such as coffee grounds and would not homogeneously wet the surface of the coffee ground particles.

According to the invention, another essential component is a thermoplastic polymer P, whose glass transition temperature Tg^{P} measured according to DIN EN ISO 11357-2 (2013-09) is 20° C.

Thermoplastic polymers P are understood to be those polymers which can be formed in a certain temperature range (≥Tg^{P}), whereby this process is reversible, which means that it can be repeated several times by cooling and reheating. However, care must be taken to ensure that the polymer is not heated to the point where thermal decomposition of the polymer begins.

According to the invention, the thermoplastic polymer P is also referred to as a binder or binding agent. In principle, thermoplastic polymers are to be distinguished from thermosetting polymers (duroplasts), which are not reversibly deformable after their manufacture, for example by curing. These are not suitable according to the invention.

Namely, it was found by the inventors that in case of using thermosetting polymers, the high oil content of manufactured boards, due to the incompatibility of the thermosetting polymers with the oil, bled out over time and the boards became very greasy and could not be further processed. With thermoplastic polymers, no bleeding of oil from coffee grounds occurred.

All thermoplastic polymers which have a glass transition temperature ≥20° C. determined according to the above-mentioned determination method can be used according to the process, such as acrylonitrile/butadiene/styrene copolymers, polyamides, polyacetates, homo- or copolymers of (meth)acrylates, Styrene acrylates, polycarbonates, polyesters, such as polyethylene terephthalates, polyolefins, such as polyethylenes or polypropylenes, acid-modified polypropylenes, polystyrenes, polyetherketones, polylactic acid, ethylene/acrylic acid copolymers, or polyvinyl chlorides.

In principle, the thermoplastic polymer P can be used in substance, in aqueous dispersion and in aqueous solution.

If the polymer P is used in substance, the polymer can be used in powder, flake or fiber form. Examples are polyethylene or polypropylene powder, flakes or fibers.

However, aqueous dispersions of polymers P are preferably used.

According to the invention, aqueous polymer solutions only play a minor role.

The polymer P is advantageously used in the form of an aqueous dispersion (hereinafter referred to as “aqueous polymer P dispersion”), produced by radically induced aqueous emulsion polymerization of ethylenically unsaturated monomers P [monomers P].

Surprisingly, it has been found by the inventors that the use of aqueous dispersions, which would be expected to have a low binding capacity for coffee ground, because coffee ground has a very high oil content, can be used advantageously, and that coffee grounds are surprisingly bound in high quantities.

This is due to the fact that the aqueous binder dispersion consists of polymer particles having a particles size in the range of 100-300 nanometers and enables a very homogeneous distribution on the surface of the coffee ground particles during wetting and drying. Additionally the thermoplastic polymers, in contrast to duroplastic polymers, have the ability to absorb oils, so that the coffee oils, which are contained in the coffee grounds in relatively high contents (up to 30% by weight) no longer function as a separating agent between particle and polymer.

According to the invention, commercially available aqueous polymer dispersions can be used advantageously, which are usually offered as binders e.g. for paints, coatings or similar, e.g. acForm®, Acronal® S940. Acronal® 12 DE, Acronal® 969 (all BASF AG).

The mixing of particulate substrate S and thermoplastic polymer P is carried out in a manner familiar to the expert, for example in a mixing drum, a fluidized bed or in a mixing extruder. The continuously or discontinuously operated mixing drum is advantageously used if the polymer P is used in substance, for example as polymer powder or as polymer fibers or in liquid form, in particular as an aqueous dispersion. A fluidized bed is used for mixing particulate substrate S and polymer P, in particular when the polymer P is present in the form of polymer powder or fibers. A mixing extruder is used in particular if the particulate substrate S was produced by crushing nutrient tissue in a mill and the polymer P is used in the form of an aqueous dispersion.

After the mixing step, the resulting substrate S/Polymer P mixture is converted into a particle layer, which is then compacted at a temperature ≥Tg^{P} to a thermoformable and/or embossable particle/polymer composite.

According to the invention, a particle layer is understood to be a layer of densely packed particles. The particle layer is obtained, for example, by spreading the polymer/substrate mixture evenly over a surface or in continuous operation on a conveyor belt. For example, the mixture can be spread in a frame, e.g. with a spreading device adapted to the frame size, until the desired weight per unit area is achieved. The surface of the particle layer can then be smoothed, if desired, e.g. with a doctor blade.

According to the invention, this particle layer can have a thickness of ≥0.3 and ≤50 cm, advantageously ≥0.3 and ≤30 cm and especially advantageously ≥0.3 and ≤10 cm and a density of ≥300 and ≤1000 g/l, often ≥300 and ≤850 g/l and often ≥500 and ≤700 g/l, if necessary after mechanical pre-compression at a temperature well below the glass transition temperature Tg^{P}.

The process according to the invention is advantageously carried out in such a way that the polymer P is used in the form of an aqueous dispersion, wherein a drying step follows process step (i), during and/or after process step (ii) or (iii), for example in a drying tower or fluidized bed dryer after process step (i) or by means of a hot air blower during or after process step (ii) or by venting during or after process step (iii).

If desired, usual additives can be added to the polymer/substrate mixture, e.g. biocides, flame retardants, waxes, fragrances, dyes, pigments, UV-protection agents and/or other usual additives.

If a commercially available polymer dispersion is used, the polymer/substrate mixture naturally contains the auxiliary substances already contained in the polymer dispersion, such as dispersants and biocides.

With particular advantage, the procedure according to the invention is such that
the substrate S is brought into contact with an aqueous dispersion of a polymer P and homogeneously mixed [process stage ia)].
   or
the substrate S is brought into contact with a powder of a polymer P and homogeneously mixed [process stage ib)]
the substrate S/polymer P mixture obtained from ia) or ib) is dried, if necessary, and then deposited [process stage ic)], then
the resulting deposited substrate S/polymer P mixture is converted into a particle layer [process stage ii)], and thereafter
the resulting particle layer is compressed to a particle/polymer composite at a temperature ≥Tg^{P} [process stage iii)].

In the context of the invention, drying is to be understood as meaning that the residual moisture content of the obtained substrate S/Polymer P mixture is reduced to ≤15 weight % and advantageously to ≤10 weight %, preferably to ≥5 and ≤10 weight %.

According to the invention, residual moisture content is understood to be the percentage difference in weight, relative to the substrate S/Polymer P mixture used, which results when 1 g of substrate S/Polymer P mixture is dried in a drying oven at 120° C. for one hour.

The particle layer thus obtained is then compressed at a temperature ≥Tg^{P} to form a thermoformable and/or embossable particle/polymer composite. Compression is understood to mean when the particle layer is compressed under pressure at a temperature ≥Tg^{P} to form a thermoformable and/or embossable polymer/particle composite. The density of the particle/polymer composite increases by a factor of ≥1 and advantageously by a factor of ≥1.5 compared to the corresponding particle layer, depending on the particulate substrate S used.

In this context, it is important to note that the particle/polymer composite according to the invention has an advantageous planar flat shape. Of course, the particle/polymer composite according to the invention can also have any non-planar three-dimensional shape, depending on the selected press mold.

In the manufacturing of the particle/polymer composite, advantageously ≥0.1 and ≤50 wt. % and with particular advantage ≥0.5 and ≤30 wt. % and advantageously ≥2 and ≤20 wt. % of polymers P (calculated as polymer, or, if a polymer dispersion is used, as the total polymer content of the dispersion) are used, based on the quantity of particulate substrate S used. That is, the composite of the invention contains a very high amount of particulate substrate, i.e. coffee grounds.

By the method according to the invention, especially particle/polymer composites are accessible, whose basis weight ≥500 and ≤30000 g/m², especially advantageously ≥1000 and ≤20000 g/m² and advantageously ≥1000 and ≤10000 g/m². The thermoformable and/or embossable particle/polymer composites obtainable by the process according to the invention are flat in one preferred design form and have a non-surface-shaped three-dimensional structure in another preferred design form.

The invention also includes the thermoformable and/or embossable particle/polymer composites obtainable by the method according to the described process of the invention.

The use of a particle/polymer composite in accordance with the invention for the manufacturing of a particle/polymer molded part which differs in its shape and/or surface structure from the thermoformable and/or embossable particle/polymer composite used is also included in the invention.

Correspondingly, the invention includes a process for the manufacturing of a particle/polymer molding, which is characterized in that a thermoformable and/or embossable particle/polymer composite according to the invention is heated to a temperature ≥Tg^{P}, the particle/polymer composite thus obtained is brought into the desired shape and/or surface structure of the particle/polymer molding at a temperature ≥Tg^{P} and the particle/polymer molding obtained is then cooled to a temperature <Tg^{P} while retaining its shape and/or surface structure.

According to the invention, the particle/polymer composite is heated to a temperature which corresponds at least to the glass transition temperature Tg^{P} of the polymer P. With advantage, the particle/polymer composite is heated to a temperature Tg^{P}+≥10° C. and with special advantage Tg^{P}+≥30° C. and the resulting particle/polymer molding is cooled to a temperature Tg^{P}−≥10° C. and with special advantage Tg^{P}−≥30° C.

It is also important that the particle/polymer molding is produced in a preferred design form by means of a heated molding press, at least one contact surface of which has a temperature ≥Tg^{P} and optionally a defined surface structure (i.e. a pattern protruding and/or protruding from the contact surface) and the shape of which corresponds to the negative shape of the particle/polymer molding and cooling of which takes place outside or inside the molding press. In this design, the heating and forming process take place in the heated molding press. Of course, according to the invention, it is also possible that the particle/polymer composite is heated outside the molding press to a temperature ≥Tg^{P} and then formed in the molding press without or with further heating to form the particle/polymer molding and, if necessary, also cooled to a temperature ≤Tg^{P}. In this preferred design, the heating and the forming and cooling processes take place separately.

In another preferred design, the heating process of the particle/polymer composite is carried out by passing it between two metal rollers arranged axially parallel and rotating in the direction of passage, whereby
(a) at least one of the metal rollers has a defined surface structure of the contact surface to the particle/polymer composite and a temperature ≥Tg^{P},
(b) the gap between the contact surfaces of the two metal rolls is smaller than the thickness of the particle/polymer composite, and
(c) the passage of the particle/polymer composite between the contact surfaces of the two metal rolls is effected at a speed corresponding to the rotational speed of the contact surfaces of the two metal rolls.

It is self-explanatory for the expert that the defined surface structure of the contact surface of the at least one metal roller represents the negative of the surface structure formed on the particle/polymer molding. In the present design, the gap width corresponds advantageously to the thickness of the particle/polymer composite multiplied by a factor ≤0.98, particularly advantageously by a factor ≤0.6 and particularly advantageously by a factor ≤0.25. In order to form optimally positive surface structures on the polymer/particle molded part, it is essential that the polymer/particle composite is passed between the contact surfaces of the two metal rolls at a speed (in m/sec) that corresponds to the rotational speed of the contact surfaces (in m/sec) of the two metal rolls. This design is particularly suitable for the manufacturing of flat, planar particle/polymer moldings with an embossed surface structure.

The thickness of the particle/polymer composite before the heating process is usually in the range ≥1 mm and ≤10 cm, often in the range ≥1 mm and ≤3 cm and often in the range ≥1 mm and ≤1 cm.

In a further advantageous design form, the process according to the invention is carried out in such a way that before or after the heating process, but before the forming step, an intermediate process step is carried out in which a sheet-like decorative material with a thickness ≤10 mm is applied to one and/or the other surface of the particle/polymer composite.

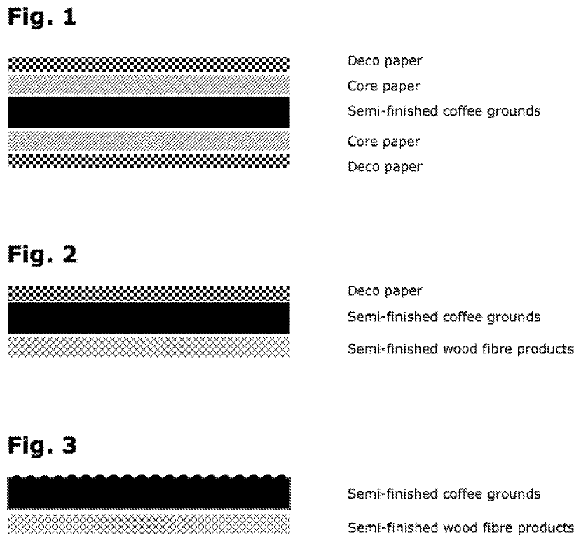

The decorative material which can be used according to the invention is advantageously a textile fabric, such as a non-woven fabric, a woven or knitted fabric made of natural or synthetic fibers, a plastic film, such as a thermoplastic polyvinyl chloride, polyolefin or polyester film, wood veneers or a HPL (high pressure laminate), CPL (continuous pressure laminate) or a melamine resin film (also known as a melamine resin overlay). An exemplary design is shown in FIG. 1.

Furthermore, according to the invention, it is possible to laminate the obtained coffee grounds composite semi-finished product boards with common wood-based s such as chipboard, OSB (oriented strand board) or MDF (medium density fiberboard) boards, but especially with wood fiber semi-finished product boards (e.g. Homa-Form). Such designs are shown in FIGS. 2 and 3.

Combinations are also possible, i.e. semi-finished wood fiber products and flat decorative material can be used simultaneously to build up laminates in accordance with the invention.

The flat decorative material usually has a thickness ≤10 mm. If the flat decorative material is a textile fabric or plastic film, its thickness is usually ≤3 mm, often advantageously ≤2 mm and often especially advantageously ≤1 mm. However, if the decorative material in sheet form is a wood veneer, HPL (high pressure laminate), CPL (continuous pressure laminate) or melamine resin film, its thickness is usually ≤3 mm, often advantageous ≤2 mm and often especially advantageous ≤1 mm.

According to the invention, therefore, the particle/polymer moldings accessible by the aforementioned method are also included.

According to the invention, it is also important that both the process for producing the thermoformable and/or embossable particle/polymer composite and the process for producing the particle/polymer molding can be carried out continuously or discontinuously.

The particle/polymer molded parts accessible according to the invention have good thermal dimensional stability as well as good mechanical properties and are therefore advantageously suitable as elements in buildings, for example as wall panels, floor elements, room dividers, partition walls, ceiling panels, door leaves or wall decorating parts and also in furniture as molded furniture parts, for example as seat or back surfaces. The use of the particle/polymer moldings as elements in buildings and in furniture is therefore preferred according to the invention.

Generally, the water content before pressing is a problem when using thermosetting binders. As the mixture of thermosetting binder and coffee grounds has to be compacted to the final product in one step, since post-compaction is not possible, the water content has to be very low at the beginning (<3%) to prevent bubble formation or bursting.

Chipboard, i.e. wood particles plus thermosetting binders, is therefore only produced up to a density of 0.7 g/cm³. If these were compressed to higher densities during pressing and hardening of the binder in the press, bubbles and bursts would form after opening the press due to the high water vapor pressure (pressing at 180-220° C.=8-12 bar water vapor pressure), which would tear the board open and make it unusable.

Due to the density below 1 g/cm³ the chipboard is porous and the water vapor can evaporate during the process.

This behavior is also known in the production of HPL, CPL or synthetic resin pressed wood. PF resin impregnated papers or veneers are pressed into boards in hot presses and hardened. The residual moisture content of the impregnated paper or veneer must be below 3%, otherwise bubbles and bursts will occur.

However, in order to produce mechanically stable boards with coffee grounds and especially high percentages of them, it is necessary to obtain high densities.

If a mixture of coffee grounds and binder were compressed to densities >1.0 g/cm³ in the first pressing step, bubbles and bursts would also occur.

Therefore, the invention enables for the first time the production of panels having a very high density from coffee grounds in an overall two-step process as defined in claim 9.

It has been shown that, according to the invention, when using thermoplastic binders, a sheet (prepreg) with a lower density can be produced in a first process step, which can then be pressed to higher densities in a second process step. This is possible because in the first step so much water can evaporate and escape that no bubbles or bursting occurs in the second pressing step.

Tests carried out by the inventors showed that the densities of the composites must be higher than 1 g/cm³, but this could not be achieved in one pressing step.

The use of thermoplastic binders according to the invention showed in a surprising way:
a good distribution of the binders on the coffee grounds, even if binders in aqueous phase are used
good oil compatibility by absorption of the oil in the polymer itself (no bleeding)
that high density molded parts with good mechanical properties can be produced by a two-step process.

### EXAMPLES

### Gluing of Coffee Grounds

Determination of the absorption behavior of different binders (solutions and dispersions) on coffee grounds powder in the mixer, as well as further processing into plates.

### Test Conditions

Substrate: coffee grounds with a moisture content of about 100%.

Binder: different variations:
1. Acronal S 940 (Tg approx. 79° C.) FG: 50% FG: 50
2. Acronal 12 DE (Tg approx. 68° C.) FG: 40
3. Acronal 969 (Tg approx. 70° C.) FG: 40
4. acForm Power 2888 (Tg approx. 90° C.) FG: 50% FG

Binder quantity atro (absolutely dry): should be 15 to 20%

Mixer: Kenwood mixer (type KMX750DR)

### Implementation

The coffee grounds are dried in a drying cabinet, under normal conditions when drying powdery substrates, to a residual moisture content of less than 5%. The dried powder is then placed in the container of the kitchen mixer. To this end, undiluted binder dispersions are added while stirring, the amount of binder dispersion being based on the coffee grounds presented. Depending on the amount of binder added and the solids content of the binder, the coffee grounds/binder mixture, after thorough mixing, is reduced again in a drying cabinet to a residual moisture of less than 15%. Random samples are taken from the glued coffee grounds powder thus obtained for analysis and evaluation of the gluing quality.

### Assessments and Testing

Three different methods are used to determine the quality of the binding agent on the coffee grounds.
Assessment of the fine dust content of a sample under the microscope.
Evaluation of the glued coffee grounds powder under the microscope.
Sedimentation behavior during board manufacturing—does the binder settle as a fine powder on the underside of the board?

The mechanical properties are tested on pressed coffee grounds.

### Carrying Out the Tests and Evaluation:

To determine the fine dust content, a sample of the glued coffee grounds is scattered on a black cardboard (DIN A4). The first assessment of the fine dust content is made with the naked eye. Binder not bound to the coffee grounds powder can be easily distinguished from the powder, as the binder can be recognized as an almost spherical white particle, unlike the dark coffee grounds powder.

A more precise assessment of the proportions of binder particles to coffee particles is carried out on the samples by microscopic observation (10-60-fold) and evaluation.

The sedimentation behavior during the scattering of the glued coffee grounds powder to form plates is also visible to the naked eye. For this purpose, the coffee grounds powder obtained is scattered in a scattering box (250×250 mm) to form an even layer of particles and pre-compressed (greater than 0.5 g/cm³ and less than 0.8 g/cm³). The particle cake thus obtained is then fed into a press preheated to 160° C. and pressed to a density of approx. 0.8 g/cm³ at a pressing rate of 10 seconds per mm plate thickness. For example, a 5 mm thick board is pressed for 50 seconds and a 3 mm thick board for 30 seconds.

The assessment of the sedimentation behavior (separation of fine dust content (=binder) and coffee grounds powder) during spreading is determined visually with the naked eye. The surfaces of the pressed particle plates are evaluated. In the absence of sedimentation, which is synonymous with good absorption of the binder onto the coffee grounds, the upper and lower surfaces of the pressed plates look the same. If the binder does not attach well to the coffee grounds (high fine dust content), this fine dust will settle more and more on the underside of the particle cake during scattering, which will become visible during pressing. The upper side of the plates then shows a coarse particle structure and a relatively poor bonding of the particles to each other, whereas the underside is very smooth and shows good bonding.

Surprisingly, it was found that even with the samples that had a high dust content or showed an uneven binder distribution and/or sedimentation, coffee grounds with very good mechanical properties could be obtained.

### Testing Results

### Fine Dust Content

1. Acronal S 940 (Tg approx. 79° C.) very high dust content
2. Acronal 12 DE (Tg approx. 68° C.) no dust content—clumping of the CSF
3. Acronal A 969 (Tg approx. 70° C.) very low dust content
4. acForm Power 2888 (Tg approx. 90° C.) no dust content to be detected

### Evaluation of the Glued Coffee Grounds Powder Under the Microscope

1. Acronal S 940 (Tg approx. 79° C.) hardly any binder on the CG, powder
2. Acronal 12 DE (Tg approx. 68° C.) baking of the coffee grounds powder
3. Acronal A 969 (Tg approx. 70° C.) moderate distribution, occasionally in powder form
4. acForm Power 2888 (Tg approx. 90° C.) even distribution, no powder

Sedimentation Behavior During Plate Manufacture
1. Acronal S 940 (Tg approx. 79° C.) very high sedimentation
2. Acronal 12 DE (Tg approx. 68° C.) uneven powder distribution
3. Acronal A 969 (Tg approx. 70° C.) low sedimentation
4. acForm Power 2888 (Tg approx. 90° C.) no sedimentation

### Mechanical Properties

### Pressing of a Scattered Coffee Grounds Particle Layer

In a wooden box measuring 250×250 mm, the glued coffee grounds powder obtained as above is spread as evenly as possible over the entire surface with a residual moisture content of 8%. The powder cake (particle pile) thus obtained is pre-compressed with a wooden plate and then compacted in a hot press with a pressing rate of 10 s/mm at 160° C. to a density of 0.8 g/cm³. Coffee grounds plates produced in this way serve as a preliminary stage for further processing. These semi-finished boards can be stored for cooling and until further processing, whereby the residual moisture is adjusted to 5%.

These semi-finished boards are subjected to further pressing to determine their mechanical properties. This second pressing takes place at temperatures between 100-160° C., preferably at 120-140° C. In this process, the semi-finished coffee boards are pressed together with decorative material, which is positioned on both surfaces so that a sandwich structure is created in which the semi-finished coffee board forms the core between two decorative layers and the density of the semi-finished coffee boards is further increased so that the overall composite has a density of 1.0-1.2 g/cm³.

A wide variety of decorative materials can be used as decorative layers. Without limiting these, HPL, CPL or decorative layers of natural fiber fleece, which are also equipped with resins, are examples.

In this example, core papers glued with resin are used to determine the mechanical properties, as in the manufacturing of HPL boards.

The structure of the layers is as follows:
Outer layers:
3 resin-impregnated core papers each with a basis weight of 120 g/m² per surface of the coffee grounds
Core layer: semi-finished coffee plate

The mechanical tests are carried out on the plates produced in this way.

### Example 1

Instruction for the manufacture of components from glued coffee grounds and a semi-finished wood fiber product* for the manufacturing of 3-dimensional molded parts

*thermoplastic bonded wood fiber board

### Drying Coffee Grounds

Dry the coffee grounds in the drying cabinet at 90° C. after reference to a residual moisture of <10%. The coffee grounds can be stored with this humidity without mold formation.

### Gluing Coffee Grounds

Place 1 kg as above dried coffee grounds in the Kenwood mixer (type KMX750DR) and slowly add the calculated binder (B) quantity while stirring. At a target ratio of 80:20 (CG:B; solid:solid) 500 ml of a 50% dispersion are added to the coffee grounds. After the addition, stir for another 2 minutes, mix again with a spoon and continue stirring for another 2 minutes in the mixer. The moisture can be determined on coffee grounds glued in this way.

### Drying Glued Coffee Grounds

If necessary, the glued coffee grounds are dried at 90° C. to a residual moisture of <15%. The solids content is determined.

Manufacturing of Semi-Finished Products from Glued Coffee Grounds

In wooden frames of different sizes, the sieved coffee grounds are distributed as evenly as possible over the surface. This can be done with a spreading device that is adapted to the wooden frame. The weight per unit area is calculated on the basis of the quantity of coffee grounds dried as above and at 120° C. the desired density of 0.75-0.9 g/cm³ is pressed between two Teflon foils. In a first step the press is closed to a pressure of 10 bar and after 90 seconds it is released for airing. In the second step, the press is moved towards the final thickness for 60 seconds. After removal from the press, cooling takes place between two aluminum plates. The humidity of the semi-finished product should be about <15%.

Manufacturing of Components from Coffee Grounds and Wood Fiber Semi-Finished Products

### 1. Preheating of the Semi-Finished Products

Wood fiber and coffee grounds are preheated together at 110° C. for 90 seconds between two Teflon foils at a pressure of <10 bar. The wood fiber semi-finished product loses about 1% moisture. The initial moisture content should be <15%.

### 2. Form Pressing of the Preheated Semi-Finished Products

Immediately after preheating, the material is pressed in the forming tool at 120° C. within 60 seconds to the set density of 1.0-1.1 g/cm³. The calculation of the thickness refers to the weight per unit area of the semi-finished products including moisture.

### 3. Cooling of the Molded Parts

After pressing, the molded parts are removed from the mold and press and left at RT to cool.

### Example 2 (See FIG. 1)

Specification for the Manufacture of Components from Glued Coffee Grounds and Decorative Surfaces for the Manufacturing of Flat Moldings (Plates)

### Drying Coffee Grounds

Dry the coffee grounds in the drying cabinet at 90° C. after reference to a residual moisture of <10%. The coffee grounds can be stored with this humidity without mold formation.

### Gluing Coffee Grounds

Place 1 kg as above dried coffee grounds in the Kenwood mixer (type KMX750DR) and slowly add the calculated binder (B) quantity while stirring. At a target ratio of 80:20 (CG:B; solid:solid), 500 ml of a 50% dispersion are added to the coffee grounds. After the addition, stir for another 2 minutes, mix again with a spoon and continue stirring for another 2 minutes in the mixer. The moisture can be determined on coffee grounds glued in this way.

### Drying Glued Coffee Grounds

If necessary, the glued coffee grounds are dried at 90° C. to a residual moisture of <15%. The solids content is determined.

Manufacturing of Semi-Finished Products from Glued Coffee Grounds

In wooden frames of different sizes, the sieved coffee grounds are distributed as evenly as possible over the surface. This can be done with a spreading device that is adapted to the wooden frame. The weight per unit area is calculated on the basis of the quantity of coffee grounds dried as above and at 120° C. the desired density of 0.75-0.9 g/cm³ is pressed between two Teflon foils. In a first step the press is closed to a pressure of 10 bar and after 90 seconds it is released for airing. In the second step, the press is moved towards the final thickness for 60 seconds. After removal from the press, cooling takes place between two aluminum plates. The humidity of the semi-finished product should be about <15%.

Manufacture of the Components from Semi-Finished Coffee Grounds and Decor
1. Depending on the mechanical properties to be achieved, 1× layers of impregnated core paper, known to experts from HPL manufacturing, and a corresponding decor paper are positioned on the top and bottom of the coffee grounds semi-finished product (see FIG. 1) and compressed together at 140° C. for 300 seconds between two Teflon films or structured press plates at a pressure >10 bar to the desired average density of 1.0-1.1 g/cm³.
2. After pressing, the decor core paper coffee grounds laminate is removed from the press and placed between two aluminum plates to cool.

### Physical Measurement Data for Example 2

1. Manufacturing the Plate from Glued Coffee Grounds at 140° C.
Spreading frame format: 30×20×2 cm (volume=1200 cm³)
Nominal density: 0.85 g/cm³
In the spreading frame, according to the table, glued CG powder is spread and pre-compressed in the press to the desired density.

| | | | | Distance | | | |
|---|---|---|---|---|---|---|---|
| Semi-finished | Weight | Weight | Areas-weight | press | Thickness | Format | Density |
| products No. | wet g | dry g | g/m² | mm | mm | cm | g/cm³ |
| 1 | 578 | 550 | 9633 | 11.3 | 11.1 | 30 × 20 | 0.87 |
| 2 | 580 | 551 | 9666 | 11.2 | 11.2 | 30 × 20 | 0.85 |

2. Pressing of the Semi-Finished Product with Core Paper, Decor and Overlay to a Nominal Density of 1.05 g/cm³

The semi-finished products from 1. are pressed to the target density according to the table with and without paper layers.

| Com- | Core | | | semi-finished | Total- | Areas- | Press | Press | Board | Board |
|---|---|---|---|---|---|---|---|---|---|---|
| ponent | paper | Décor | Overlay | coffee ground | weight/ | weight | temp. i/ | distance/ | thickness/ | Density |
| No. | No/g | No/g | No/g | 1 piece | g | g/m² | ° C. | mm | mm | g/cm³ |
| 1 | 0 | 0 | 0 | 578 | 578 | 9633 | 140 | 9.1 | 9.15 | 1.05 |
| 2 | 6/40.6 | 2/12.3 | 2/5.8 | 550 | 600 | 10145 | 140 | 9.6 | 9.65 | 1.05 |

### 3. Testing the Mechanical Properties of Raw Panel 1 and Sandwich 2

The modulus of elasticity and flexural strength of the plates produced in point 2. are determined according to ISO 14 125 W.

| | | | |
|---|---|---|---|
| Record number | unit | 1 | 2 |
| Panel thickness | mm | 9.45 | 9.65 |
| Density | g/cm³ | 1.05 | 1.05 |
| Number of core papers | | 0 | 2 × 3 |
| Bending E-Module ISO | N/mm² | 377 | 4215 |
| 14125 W 4 200N | | | |
| Standard deviation | N/mm² | 22 | 640 |
| Flexural Strength | N/mm² | 4 | 66 |
| Standard deviation | N/mm² | 0.3 | 6 |

### Example 3 (see FIG. 2)

Instruction for the manufacture of components from glued coffee grounds and a wood fiber carrier and decorative surface for the manufacturing of 3-dimensional molded articles with surface design

### Drying Coffee Grounds

Dry the coffee grounds in the drying cabinet at 90° C. after reference to a residual moisture of ≤10%. The coffee grounds can be stored with this humidity without mold formation.

### Gluing Coffee Grounds

Place 1 kg as above dried coffee grounds in the Kenwood mixer (type KMX750DR) and slowly add the calculated binder quantity while stirring. At a target ratio of 80:20 (CG:B; solid:solid) 500 ml of a 50% dispersion are added to the coffee grounds. After the addition, stir for another 2 minutes, mix again with a spoon and continue stirring for another 2 minutes in the mixer. The moisture can be determined on coffee grounds glued in this way.

### Drying Glued Coffee Grounds

If necessary, the glued coffee grounds are dried at 90° C. to a residual moisture of <15%. The solids content is determined.

Manufacturing of Semi-Finished Products from Glued Coffee Grounds

In wooden frames of different sizes, the sieved coffee grounds are distributed as evenly as possible over the surface. This can be done with a spreading device that is adapted to the wooden frame. The weight per unit area is calculated on the basis of the quantity of coffee grounds dried as above and at 120° C. the desired density of 0.75-0.9 g/cm³ is pressed between two Teflon foils. In a first step the press is closed to a pressure of 10 bar and after 90 seconds it is released for airing. In the second step, the press is moved towards the final thickness for 60 seconds. After removal from the press, cooling takes place between two aluminum plates. The humidity of the semi-finished product should be about <15%.

Manufacturing of Components from Coffee Grounds and Wood Fiber Semi-Finished Products

### 1. Preheating of the Semi-Finished Products

Wood fiber and coffee grounds are preheated together at 110° C. for 90 seconds between two Teflon foils at a pressure of <10 bar. The wood fiber semi-finished product loses about 1% moisture. The initial moisture content should be between 5 and 6%.
   2. Form Pressing of the Preheated Semi-Finished Products with Decorative Surface
Immediately after preheating, the desired decorative material such as impregnated decorative paper, pre-impregnated or post-impregnated paper is pressed on both sides of the wood fiber/coffee grounds combination (see FIG. 2) in the molding tool at 140° C. within 180 seconds to the set density of 1.0 g/cm³. The calculation of the thickness refers to the weight per unit area of the semi-finished products and decor papers including moisture.

### 3. Cooling of the Molded Parts

After pressing, the molded parts are removed from the mold and press and left at RT to cool.

### Example 4 (see FIG. 3)

Specification for the manufacture of components from glued coffee grounds and a semi-finished wood fiber product* for the manufacturing of 3-dimensional molded bodies with a structured surface

*thermoplastic bonded wood fiber board

### Drying Coffee Grounds

Dry the coffee grounds in the drying cabinet at 90° C. after reference to a residual moisture of <10%. The coffee grounds can be stored with this humidity without mold formation.

### Gluing Coffee Grounds

Place 1 kg as above dried coffee grounds in the Kenwood mixer (type KMX750DR) and slowly add the calculated binder quantity while stirring. At a target ratio of 80:20 (CG:B; solid:solid) 500 ml of a 50% dispersion are added to the coffee grounds. After the addition, stir for another 2 minutes, mix again with a spoon and continue stirring for another 2 minutes in the mixer. The moisture can be determined on coffee grounds glued in this way.

### Drying Glued Coffee Grounds

If necessary, the glued coffee grounds are dried at 90° C. to a residual moisture of <15%. The solids content is determined.

Manufacturing of Semi-Finished Products from Glued Coffee Grounds

In wooden frames of different sizes, the sieved coffee grounds are distributed as evenly as possible over the surface. This can be done with a spreading device that is adapted to the wooden frame. The weight per unit area is calculated on the basis of the quantity of coffee grounds dried as above and at 120° C. the desired density of 0.75-0.9 g/cm³ is pressed between two Teflon foils. In a first step the press is closed to a pressure of 10 bar and after 90 seconds it is released for airing. In the second step, the press is moved towards the final thickness for 60 seconds. After removal from the press, cooling takes place between two aluminum plates. The humidity of the semi-finished product should be about <15%.

Manufacturing of Components from Coffee Grounds and Wood Fiber Semi-Finished Products

### 1. Preheating of the Semi-Finished Products

Wood fiber and coffee grounds are preheated together at 110° C. for 90 seconds between two Teflon foils at a pressure of <10 bar. The wood fiber semi-finished product loses about 1% moisture. The initial moisture content should be <15%.

### 2. Form Pressing of the Preheated Semi-Finished Products

Immediately after preheating, the material is pressed in the forming tool at 120° C. within 60 seconds to the set density of 1.0-1.1 g/cm³. A pressing tool with a structured negative surface is used on one side. The calculation of the thickness refers to the weight per unit area of the semi-finished products including moisture.

### 3. Cooling of the Molded Parts

After pressing, the molded parts are removed from the mold and press and left at RT to cool.

1-12. (canceled)

13: A process of manufacturing a particle-polymer composite, comprising
(i) providing a particulate biological substrate S comprising nutritive tissue,
(ii) providing a polymer P,
(iii) mixing the substrate S and the polymer P,
(iv) converting the substrate S/polymer P mixture into a particle layer, and
(v) densifying the particle layer at a temperature≤the glass transition temperature of the polymer P (Tg^{P}) to form a particle-polymer composite,
wherein
(a) substrate S comprises extracted ground coffee beans; and
(b) polymer P is thermoplastic and has a Tg^{P}≥20° C. measured according to DIN EN ISO 11357-2 (2013-09).

14: The process of claim 13, wherein polymer P is provided in the form of an aqueous dispersion, and wherein the process further comprises drying.

15: The process of claim 14, wherein the drying is carried out after mixing.

16: The process of claim 13, wherein polymer P is provided in powder form.

17: The process of claim 13, comprising,
(i) bringing together and mixing the (a) substrate S with (b) powder P in the form of (b1) an aqueous dispersion or (b2) a powder, to obtain a mixture,
(ii) depositing the mixture,
(iii) converting the deposited mixture into a particle layer, and
(iv) compressing the particle layer at a temperature ≥Tg^{P} to form a particle-polymer composite.

18: The process of claim 13, wherein the weight ratio of substrate S to polymer P is within the range of ≥1 to ≤30.

19: The process of claim 13, wherein the particle-polymer composite has a basis weight within the range of ≥500 to ≤30 000 g/m².

20: A particle-polymer composite obtained by the process of claim 13.

21: A particle-polymer composite obtained by the process of claim 14.

22: A particle-polymer composite obtained by the process of claim 16.

23: A particle-polymer composite obtained by the process of claim 17.

24: A process of producing an article comprising, introducing into a mold, the particle-polymer composite of claim 20, to afford a particle-polymer molded body which differs in at least one of shape and surface structure from said particle-polymer composite of claim 20.

25: A process of producing an article comprising, introducing into a mold, the particle-polymer composite of claim 21, to afford a particle-polymer molded body
which differs in at least one of shape and surface structure from said particle-polymer composite of claim 21.

26: A process of producing an article, the process comprising, introducing into a mold, the particle-polymer composite of claim 22, to afford a particle-polymer molded body which differs in at least one of shape and surface structure from said particle-polymer composite of claim 22.

27: A process of producing an article, the process comprising, introducing into a mold, the particle-polymer composite of claim 23, to afford a particle-polymer molded body which differs in at least one of shape and surface structure from said particle-polymer composite of claim 23.

28: A process of producing a molded body, the process comprising:
(i) heating the particle-polymer composite of claim 20 to a temperature ≥Tg^{P},
(ii) introducing said heated particle-polymer composite into a mold and molding at a temperature ≥Tg^{P}, to afford a molded body having at least one of a shape and a surface structure that differs from said particle-polymer composite, and
(iii) cooling the molded body to a temperature <Tg^{P} while retaining said at least one of a shape and surface structure that differs from said particle-polymer composite.

29: A process for producing a molded body, comprising:
(i) providing the particle-polymer composite of claim 20,
(ii) providing at least one of (a) a support structure, (b) a protective layer or (c) an overlay,
(iii) applying said particle-polymer composite to at least one of said (a) support structure, (b) protective layer and (c) overlay,
(iv) heating the so-applied particle-polymer composite to a temperature ≥Tg^{P},
(v) admitting the heated particle-polymer composite to a mold and molding at a temperature ≥Tg^{P},
(vi) cooling the particle-polymer composite to a temperature ≤Tg^{P}, and
(vii) removing the cooled particle-polymer composite from the mold, to form a molded body, wherein the molded body maintains the shape of the mold.

30: A molded body obtained by the process of claim 28.

31: A molded body obtained by the process of claim 29.

32: An architectural or furniture element, product or fixture comprising the particle-polymer molded body of claim 30.
